(19) United States
(12) Patent Application Publication
(10) Pub. No.: US 2025/0291704 A1
(43) Pub. Date: Sep. 18, 2025

(54) METHOD AND COMPUTER PROGRAM FOR AUTOMATICALLY GENERATING COMMUNICATION INTERFACES IN ALGORITHMS FROM THE FIELD OF ARTIFICIAL INTELLIGENCE

(71) Applicant: Siemens Mobility GmbH, München (DE)

(72) Inventor: Andreas Wahl, Erlangen (DE)

(21) Appl. No.: 18/861,294

(22) PCT Filed: Apr. 12, 2023
(86) PCT No.: PCT/EP2023/059485

§ 371 Date: Oct. 29, 2024

(30) Foreign Application Priority Data
Apr. 29, 2022 (DE) 10 2022 204 238.7

(51) Int. Cl. G06F 11/3668

(52) U.S. Cl. CPC G06F 11/3668

(57) ABSTRACT

A computer program and method for producing a further computer program product starting from a source text of artificial intelligence algorithms with the following steps: a) providing a library of semantic annotations; b) analyzing the source text with a source text analysis component for the presence of the semantic annotations in the source text; c) generating a communication interface with a communication interface generator; d) analyzing the source text for the presence of a semantic annotation in the source text and transferring the logic sequence from the library that is uniquely linked to the semantic annotation to the communication interface generator; e) reading the logic sequence that has been transferred and is linked to the semantic annotation present in the source text, and f) generating a communication interface on the basis of the logic sequence; and g) embedding the generated communication interface in the computer program product.

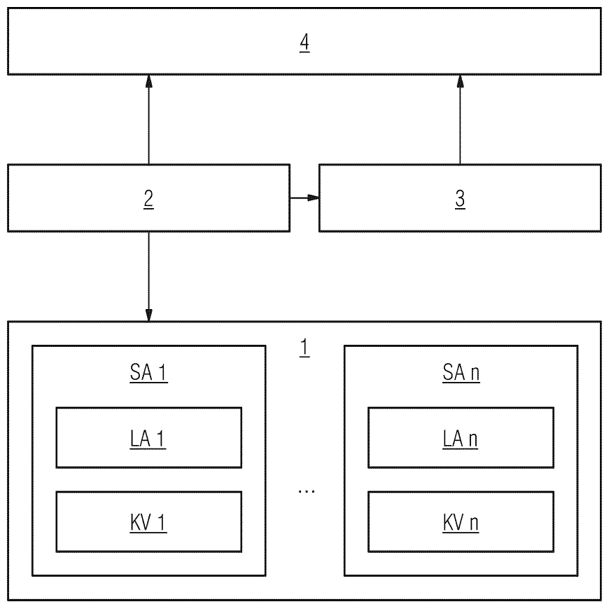

The invention relates to a method and a computer program for producing a further computer program product starting from a source text of artificial intelligence algorithms.

Specialized software tools have become known for developing algorithms and methods from the field of artificial intelligence. These software tools, for example “Jupyter Notebooks” (see also https://jupyter.org/), are suitable for supporting iterative and explorative work by what are known as data scientists during the development of artificial intelligence algorithms. However, they are not suitable for transferring the developed algorithms and methods into products that can be shipped to customers, firstly because these software tools are not capable of providing technology-agnostic interfaces with which the algorithms and methods can be directly integrated into customer applications and processes. Secondly, the source text of the algorithms and methods cannot be concealed from the customer.

It has hence until now been common practice to rework the source text of the prototype implementation in order to obtain a usable product for the customer. In this case all source text dependencies for the software tools mentioned are first removed and communication interfaces, such as for example “REST” interfaces, are added to the source text, and can be used as so-called APIs (Application Programming Interfaces) to address the algorithms and methods via networks. The algorithms and methods can then be made available to the customer via the added communication interfaces for execution, e.g. for access via the Internet. The customer can thereby initiate the execution of the algorithms and methods via these interfaces and consume the results, but has no possibility of viewing the underlying source text.

Creating and adding the communication interfaces in this case requires a deep understanding of the communication interfaces as such as well as of the resulting implications, for example the validation of inputs made via a network. Hence software developers typically take on the task of transferring the prototype implementation by data scientists into a product that can be used by customers.

The object of the invention is to simplify the development of products with algorithms and methods from the field of artificial intelligence, which can be incorporated directly into any customer applications and processes.

The object is achieved by the subject matters of the independent claims. Developments and embodiments of the invention can be found in the features of the dependent claims.

An inventive method for producing a computer program product starting from a source text of artificial intelligence algorithms comprises the following method steps:
a. providing a library of semantic annotations, comprising:
   semantic annotations for marking source text constructs of the source text of artificial intelligence algorithms;
   logic sequences which are uniquely linked to the semantic annotations for generating communication interfaces and for embedding marked source text constructs into the computer program product to be produced;
b. providing a source text analysis component for analyzing the source text for the presence of the semantic annotations in the source text;
c. providing a communication interface generator for generating at least one communication interface;
d. using the source text analysis component to analyze the source text for the presence of the semantic annotations in the source text and transferring the logic sequences, which are uniquely linked to the semantic annotations present in the source text, from the library to the communication interface generator;
e. using the communication interface generator to read the transferred logic sequences which are uniquely linked to the semantic annotations present in the source text and
f. using the communication interface generator to generate communication interfaces on the basis of the logic sequences read;
g. embedding the generated communication interfaces into the computer program product to be produced.

The inventive method is a computer-implemented method.

At least one semantic annotation is present in the source text if at least one source text construct of the source text of artificial intelligence algorithms is marked with at least one semantic annotation. In the analysis of the source text in accordance with method step d. an analysis is hence made to see whether at least one source text construct of the source text is provided with a semantic annotation from the library. If at least one semantic annotation is present in the source text, then in accordance with method step d. the logic sequence which is uniquely linked to the at least one semantic annotation present in the source text is transferred from the library to the communication interface generator. In accordance with method step e. this at least one transferred logic sequence is read from the communication interface generator, whereupon at least one communication interface is generated by the communication interface generator on the basis of this at least one read logic sequence in accordance with method step f. In accordance with method step h. this at least one generated communication interface is then embedded into the computer program product to be produced. The communication interfaces embedded in the computer program product produced serve to retrieve the source test constructs marked with the semantic annotations and thus to retrieve the artificial intelligence algorithms represented by the marked source text constructs.

In accordance with the invention a source text provided with semantic annotations, i.e. a source text with at least one source text construct which is marked with at least one semantic annotation from the library of semantic annotations, is used as input and from this a computer program product, in particular an API product, is generated, in particular dynamically at runtime. A computer program product generated in this way comprises communication interfaces for embedding the artificial intelligence algorithms of the source text comprising the artificial intelligence algorithms into applications or processes. The method is used during the development of the applications or processes for automatically generating the communication interfaces and for embedding the artificial intelligence algorithms retrieved by the communication interfaces into the generated computer program product.

An inventive computer program product for producing a further computer program product comprises commands which when the program is executed by a suitable computer cause said computer to execute the inventive method. The computer for executing the inventive computer program product can be a terminal or a server. Computer program products can also be referred to simply as computer programs.

In connection with the invention, “producing” can also be referred to synonymously as “creating” or “generating”. The method thus results in the creation of a computer program product starting from a source text of artificial intelligence algorithms. The corresponding inventive computer program product serves analogously for creating a further computer program product.

In this sense, the “further” computer program product thus relates to the computer program product produced or created during the execution of the inventive method.

For better differentiation, the term computer program is used below if the computer program product for producing or creating the (further) computer program product to be created or produced is meant. In contrast, the computer program product produced or created using this computer program on execution of the inventive method is referred to as a computer program product. “Other” computer program products refers to third computer program products, which for example access the communication interfaces of the generated computer program product.

The source text is in this case read-in by the inventive computer program for producing a computer program product and is also executed in accordance with a form of embodiment of the invention. The source text remains untouched during the execution of the inventive method. No lines of code relating in particular to the communication interfaces are supplemented and written into the source text. Rather, the semantic annotations serve as a type of jump label, which can be referenced with the generated communication interfaces, and the marked source text constructs can be addressed. At the start of the method no communication interfaces may where appropriate yet be defined in the source text. On conclusion of the method, all communication interfaces to the source text constructs in a computer program product that are marked with semantic annotations can be provided to a user.

The inventive computer program comprises in particular
a library of semantic annotations comprising
   semantic annotations for marking source text constructs of the source text of artificial intelligence algorithms;
   logic sequences uniquely linked to the semantic annotations for generating communication interfaces and for embedding the marked source text constructs into the computer program product to be produced;
a source text analysis component, suitably designed
   for analyzing the source text for the presence of the semantic annotations in the source text;
   for transferring the at least one logic sequence which is uniquely linked to the at least one semantic annotation present in the source text from the library to the communication interface generator;
a communication interface generator, suitably designed
   for reading the at least one transferred logic sequence linked to the at least one semantic annotation present in the source text;
   for generating at least one communication interface on the basis of the logic sequence read.

It can additionally be suitably designed
for embedding the at least one generated communication interface into the computer program product to be produced.

Preferably in accordance with method step f. the communication interface generator is used to generate the at least one communication interface as an application programming interface (API for short), for example as a “REST” interface, which in accordance with method step g. is embedded into the computer program product, which where appropriate is provided in accordance with method step h. The communication interface generator is correspondingly suitably designed.

The provided library of semantic annotations comprises at least one semantic annotation and at least one logic sequence uniquely linked to the at least one semantic annotation. In particular, the provided library of semantic annotations comprises any and any number of semantic annotations and logic sequences respectively uniquely linked thereto. Thus for each semantic annotation a logic sequence uniquely linked thereto is present. For the sake of clarity, the plural is mainly used below in connection with the at least one semantic annotation and the at least one logic sequence uniquely linked thereto.

Semantic annotations are predefined markings, with which certain parts of the source text, known as source text constructs, in particular certain functions and function parameters or input or output variables or results of the artificial intelligence algorithms, are marked or in particular can be marked subsequently. Accordingly they can also be referred to as semantic source text annotations. Belonging to each of these markings is a predefined logic sequence which lays down when and how the marked source text constructs are retrieved. Each logic sequence thus comprises a predefined rule for generating a communication interface and thus for further processing, in particular for execution, and for embedding the source text constructs of the artificial intelligence algorithms marked with the semantic annotations in the generated computer program product.

The semantic annotations and the logic sequences linked thereto fulfill two different purposes: firstly they indicate the parts of the source text for which communication interfaces, in particular APIs, should be generated. Secondly, they indicate which information should be exchanged as request and response via these communication interfaces. Semantic annotations in this case conceal all technical details of the communication interfaces to be generated: the respective source text markings capture only the semantic meaning of the annotated source text constructs and do not allow any conclusions to be drawn about the communication interfaces to be generated.

In addition to the library, in accordance with the method a source text analysis component for analyzing the source text for the presence of the semantic annotations from the library in the source text and a communication interface generator for generating at least one communication interface are provided.

The source text analysis component is responsible for the accesses to the library. This component examines the source test transferred to it for the presence of markings with the semantic annotations that are stored in the library. To this end the source text can first be searched for markings with semantic annotations and these can be compared with the semantic annotations stored in the library. It is also possible to speak here of capturing semantic annotations in the source text and recognizing the semantic annotations provided in the library.

The logic sequences assigned to the recognized semantic annotations and uniquely linked thereto are then transferred from the library to the communication interface generator. The communication interface generator then generates all required communication interfaces on the basis of and thus in accordance with the rule of these logic sequences. To this end the information from the logic sequences is read and processed in accordance with a predefined algorithm. The logic sequences respectively comprise all specifications and parameters that are sufficient to be able to generate a communication interface.

Finally the generated communication interfaces are embedded into the computer program product. This is done in accordance with a first development using a communication interface provision component. In a further development the generated computer program product is provided using the communication interface provision component, in order to be able to access the generated communication interfaces and via these the artificial intelligence algorithms, in particular via a network. The communication interface provision component is responsible for making the generated communication interfaces accessible via a network and thus enables access to the source text constructs marked with the semantic annotations.

In accordance with the development mentioned, the method comprises
at least the following method step preceding method step f.:
   providing a communication interface provision component;
the following additional feature in method step f.:
   transferring the generated communication interfaces to the communication interface provision component;
wherein method step g. comprises:
   g. using the communication interface provision component to embed the transferred communication interfaces into the computer program product;
following method step g.:
   h. using the communication interface provision component to provide the generated computer program product comprising the at least one generated communication interface.

A developed computer program for producing a computer program product accordingly comprises a communication interface provision component, which is suitably designed for the provision of the generated computer program product by the communication interface provision component, wherein the communication interface generator is henceforth suitably designed to transfer the generated computer program product to the communication interface provision component.

All communication interfaces generated by the communication interface generator are transferred to the communication interface provision component and are embedded into the computer program product, for example a web application, so that the entirety of all communication interfaces is available for access by a user in a computer program product. Thus the generated communication interfaces are also provided for access by further, other computer program products such as applications or processes. The communication interface provision component is accordingly suitably designed to embed the transferred communication interfaces into the computer program product and to provide the computer program product.

In a further development the generated computer program product is a web application. A web application (web ap) is an application program which is stored on a remote server and provided over the Internet via a browser interface. The communication interface provision component is accordingly suitable for providing the generated computer program product via a browser interface.

A further development of the inventive method consists in that at least method step d. is preceded by:
marking at least one source text construct of the source text with at least one semantic annotation from the library.

This method step can of course already precede method step a. Marking the source text with semantic annotations in accordance with the library can be done manually, for example by a data scientist. When creating the source text or else subsequently, i.e. after creating the source text, selected source text constructs relating to particular artificial intelligence algorithms are annotated, i.e. are marked with the semantic annotations in accordance with the library, whereby the input or output of values to or from the algorithms is determined by the predefined logic sequences uniquely linked to the semantic annotations. The developer, in particular the data scientist, of the algorithms knows best about the algorithms and how they should be retrieved. However, the developer does not have to worry about the concrete design of the communication interfaces for retrieving the algorithms. This is done automatically by the inventive computer program. A further advantage of the invention is thus that an additional, specialized software developer is not required for the creation and configuration of the communication interfaces.

In a further development, method step a. can be preceded by:
providing a source text with artificial intelligence algorithms comprising at least one semantic annotation of at least one source text construct of the source text;
providing an input interface for reading-in the source text and for transferring the source text to the source text analysis component;
transferring the source text read-in by the input interface to the source text-analysis component.

The computer program for producing a computer program product can accordingly have an input interface which is suitably designed for:
reading-in the source text of artificial intelligence algorithms comprising the semantic annotations for marking source text constructs of the source text of artificial intelligence algorithms in the source text;
transferring the read-in source text to the source text-analysis component.

In accordance with a further development, the library of semantic annotations provided in accordance with method step a. henceforth comprises at least one configuration template which is uniquely linked to at least one logic sequence and comprises definitions of configuration parameters modifying at least the configuration parameters of the logic sequence, wherein method step d. comprises:
d. using the source text analysis component to analyze the source text for the presence of semantic annotations in the source text and transferring the logic sequences which are uniquely linked to the semantic annotations present in the source text from the library, and transferring the configuration templates which are uniquely linked to the transferred logic sequences from the library to the communication interface generator;
   and wherein method step e. comprises:
e. using the communication interface generator to read the transferred logic sequences uniquely linked to the semantic annotations present in the source text and using the communication interface generator to read the configuration templates uniquely linked to the transferred logic sequences;
   wherein method step e. is followed by and method step f. is preceded by:
ee. using the communication interface generator to generate configuration interfaces on the basis of the read logic sequences and on the basis of the read configuration templates uniquely linked to the read logic sequences, and providing the generated configuration interfaces for modifying at least the configuration parameters of the logic sequences.

Using the communication interface generator to generate and provide at least one configuration interface for the configuration of the configuration parameters of the at least one transferred logic sequence on the basis of the at least one read logic sequence and on the basis of the at least one read configuration template serves in particular to modify the configuration parameters of the read logic sequence uniquely linked to the read configuration template, dynamically at runtime.

A modification can comprise a change or adjustment and where appropriate an extension, deletion or addition of the configuration parameters of the logic sequences.

The modification can be carried out manually by a user or can be made automatically via the configuration interface using further, other computer program products.

To this end, in a further development the configuration parameters of the read logic sequence which is uniquely linked to the read configuration template can be read via the provided configuration interface and can be provided to the user for manual modification, for example via a web application, in particular output on a display screen, for example in a representation of a form. For example, the modifications are determined by changing prepopulated values.

The modifications made, for example by the user or another computer program product, are captured and transmitted to the communication interface generator using the configuration interface. The modifications transferred via the configuration interface are read by the communication interface generator and the logic sequence read from the library is modified by the communication interface generator on the basis of the read modifications. A logic sequence is now present in the communication interface generator which can have modified configuration parameters compared to the original logic sequence from the library.

Then on the basis of the modified logic sequence the communication interfaces are generated using the communication interface generator.

In accordance with a further development of the invention, method step ee. henceforth therefore comprises:
ee. using the communication interface generator to receive modifications of at least one configuration parameter of the at least one read logic sequence via the configuration interface and using the communication interface generator to modify the at least one configuration parameter of the at least one read logic sequence.

And in a further development method step f, thus comprises:
f. using the communication interface generator to generate at least one communication interface on the basis of the at least one read and modified logic sequence.

Before generating the communication interfaces, respective communication interfaces can thus be generated and provided and via these the logic sequences can be modified. Thanks to modifications to the logic sequence, the communication interfaces then generated and provided are also modified.

A generated communication interface can no longer be modified from the outside. Only internal sequences, such as a running counter for example, can adjust parameters. The inventively generated computer program product comprises all communication interfaces, but in accordance with one form of embodiment is provided without configuration interfaces. API products can in this way be made available to users “as a service” without users having to configure them themselves. It is not necessary to embed the generated configuration interface into the computer program product.

The logic sequences from the library can be prepopulated with default values, so that communication interfaces can be generated and provided even without modifications.

The configuration of the parameters is advantageously carried out at the runtime of the inventive method or at the runtime of the inventive computer program product.

The generation of the communication interface and where appropriate of the configuration interface in accordance with the corresponding method steps is preferably carried out at the runtime of the inventive method or at the runtime of the inventive computer program.

All other method steps, such as analyzing the source text or embedding the generated communication interfaces into the computer program product, are in particular likewise carried out at the runtime of the inventive computer program.

According to a further development of the invention the library can be expanded by, where appropriate any and/or any number of, semantic annotations. This can likewise be done at the runtime of the method, but in any case prior to method step d. Accordingly method step d. can be preceded by:
providing an input interface for expanding, deleting or changing contents of the provided library of semantic annotations;
expanding, deleting or changing contents of the provided library of semantic annotations.

Expanding, deleting or changing, in particular supplementing or amending, the contents of the provided library of semantic annotations thus comprises expanding, deleting or changing, in particular supplementing or amending, the semantic annotations, i.e. the expressions for marking the source text constructs as such, the logic sequences uniquely linked to the semantic annotations and where appropriate the configuration templates uniquely inked to the logic sequences.

To this end the contents of the library of semantic annotations can be read via the provided input interface and provided to the user for manual expansion, deletion or change, for example via a web application, in particular output on a display screen. The expansions, deletions or changes made by the user or another computer program product are captured and are written back into the library using the input interface.

In a further development, the input interface can also be used to extend, delete or change the source text, in particular the source text read-in using the input interface, and in particular to supplement, delete or amend semantic annotations of source text constructs.

The input interface is accordingly suitably designed.

A developed computer program for producing a computer program product accordingly comprises an input interface for expanding, deleting or changing, in particular supplementing or amending, the contents of the provided library and/or for marking at least one source text construct of the source text with at least one semantic annotation from the library.

The generated communication interfaces enable inputs, e.g. values, to be transferred to the artificial intelligence algorithms, for example also via or from a network, or for corresponding values to be output from the artificial intelligence algorithms, for example also via a network.

In a further development in this case the source text constructs of the artificial intelligence algorithms of the source text marked with the semantic annotations from the library each describe at least one algorithm for regulating, controlling or diagnosing technical devices or systems.

Accordingly the at least one generated and provided communication interface for embedding, for example for executing and for accessing via a network, the at least one source text construct of the artificial intelligence algorithms of the source text comprising the artificial intelligence algorithms marked with the at least one semantic annotation serves to regulate, control, diagnose or monitor and/or simulate technical devices, such as machines, or systems.

In a further development the provided source text of artificial intelligence algorithms comprising at least one semantic annotation of at least one source text construct is firstly transferred to the source text analysis component using an input interface. A correspondingly developed computer program comprises an input interface for reading-in the source text and for transferring the source text to the source text analysis component.

The input interface is suitably designed for reading-in a source text of artificial intelligence algorithms comprising semantic annotations as expressions for marking source text constructs of the source text of artificial intelligence algorithms in the source text. In addition, the input interface is suitably designed for transferring the source text to the source text analysis component.

The invention has many advantages. Thus prototypically implemented algorithms and methods from the field of artificial intelligence can very easily and cost-effectively be converted into products that can be directly integrated into any customer applications and processes, without however giving the customer direct access to the intellectual property of the algorithms and methods.

Various facets of the present invention contribute to a greatly increased cost effectiveness in the context of the production of algorithms and methods from the field of artificial intelligence:

Self-service offering for data scientists: the relevant parts of the source text of algorithms and methods from the field of artificial intelligence remain almost entirely untouched, instead of being completely reworked as was previously normal. The semantic annotations are a very simple concept that can also be applied directly by data scientists themselves. Thus there is no need to involve software developers in production, as is the case with comparable approaches. As a result, significant time is saved, since apart from the original authors no one needs to be familiarized with the source text. The coordination work between data scientists and software developers is also eliminated.

Incremental production of existing source text: semantic annotations can be added gradually to allow further communication interfaces to be generated as required. All parts of the source text that are not annotated are not initially taken into consideration. In this way an incremental production of existing source text is very easily possible. The communication interfaces can be controlled simply by omitting or adding semantic annotations. The resulting API product can thus be ideally tailored to the user's requirements.

Reusability of the generated API products in different contexts: the semantic annotations can be configured with parameters as required. This configuration is first carried out at the runtime of the API product via a configuration interface provided for this purpose. This means that the same source text can be used in different contexts, e.g. for different users and/or projects, because when it is executed it can be dynamically adapted to the respectively applicable requirements.

Expandability: the library of semantic annotations used by the invention can furthermore be supplemented with any additional annotations. As a result, API products created with the present invention are particularly easy to maintain, since new functions can easily be added as required. This expansion mechanism moreover makes it possible for the present invention also to be employed in external fields of application outside the production of artificial intelligence algorithms and methods, if suitable semantic annotations are created for this.

Since the source text markings of the semantic annotations do not contain any information about the communication interfaces to be generated, it is also possible with their help to map already annotated source text to other communication interfaces at a later point in time. This increases the future viability and flexibility of the API products created with the present invention, since any technology migrations can be carried out later without the involvement of the original authors.

The generated computer program product represents the direct product of the process in accordance with the inventive method, as well as the product which is produced using the inventive computer program for producing a further computer program product. It can be stored on a data storage medium.

The invention allows numerous forms of embodiment. It is explained in greater detail on the basis of the following FIGURE, in which an exemplary embodiment is represented.

The FIGURE schematically shows an overview of the invention.

A library 1 containing any number of semantic annotations SA₁ . . . SAₙ (where n is a natural number greater than 1) is provided. Each of the semantic annotations SA₁ . . . SAₙ represents an expression for marking a source text construct of a source text with artificial intelligence algorithms. Uniquely linked to each of the semantic annotations SA₁ . . . SAₙ-represented here under the same entry in the library—are a configuration template KV₁ . . . KVₙ and a logic sequence LA₁ . . . LAₙ, into which the annotated source text construct is embedded at runtime.

In addition, a source text analysis component 2, a communication interface generator 3, and a communication interface provision component 4 are provided.

The arrows between the modules characterize their connections with one another. In accordance with the arrow from the library 1 to the source text analysis component 2 the source text analysis component 2 uses the library. Analogously, the source text analysis component 2 uses the communication interface provision component 4 and the communication interface generator 3, this being illustrated with the corresponding arrows between the modules mentioned. Similarly, the communication interface generator 3 is used by the communication interface provision component 4.

Source text constructs of the source text of artificial intelligence algorithms are marked with the semantic annotations provided as expressions in the library 1.

This source text is read-in and is analyzed for the presence of corresponding semantic annotations of the library using the source text analysis component 2.

If source text constructs marked with semantic annotations from the library are identified in the source text, communication interfaces are generated using the communication interface generator 3 on the basis of the logic sequences uniquely linked to the identified semantic annotations and are provided using the communication interface provision component 4.

This will be outlined in greater detail below on the basis of a greatly simplified exemplary implementation.

Firstly a source text containing artificial intelligence algorithms is generated, for example by a data scientist, whose algorithms are transferred into an API product. Here is a source text containing two functions in the Python programming language:
def training_alorithm( )
   step1( )
   step2( )
def prediction_algorithm( )
   step1( )
   step2( )

During or after the creation of the algorithm the data scientist adds two semantic annotations @Training and @InteractivePrediction, in order to mark that the function training_algorithm( ) involves training an analytical model and the function prediction_algorithm( ) involves the interactive generation of predictions by the model.

In this or in the next step the data scientist adds declarative type definitions for the exchange of information between API and user. The data scientist also provides this with corresponding annotations @TrainingData, @PredictionRequest, @PredictionResponse, in order to indicate what information is to be requested by the user, and when, and how the API product should respond. The source text now reads as follows:
@Training
def training_alorithm(data)
   step1( )
   step2( )
@InteractivePrediction
def prediction_algorithm(data)
   step1( )
   step2( )
@TrainingData
def TrainInput:
   observations: List [float]
@PredictionRequest
class Input:
   parameter1: str
   parameter1: str
@PredictionResult
class Output:
   result: str

The source text is then executed. On the basis of all inserted semantic annotations, communication interfaces for training and prediction are now automatically generated when the annotated source text is executed, via which the user can address both the annotated functions via a network. In addition, further standardized interfaces are generated, with which the API product can be dynamically configured and its lifecycle monitored.

For each semantic annotation the following information is captured in the example:
i. Marking to be used in the source text;
   Example: @InteractivePrediction, in order to characterize a prediction function;
ii. Logic sequence into which the annotated source text construct is embedded at runtime;
   Example: logic sequence into which a prediction function annotated with @InteractivePrediction is embedded:
      Validation of the user request,
      Execution of the annotated prediction function,
      Persistent storage of the prediction result, to enable subsequent traceability,
      Sending the prediction result to the user as a response;
iii. Configuration template containing the definitions of all configuration parameters with which the logic sequence can be dynamically modified depending on requirements at runtime;
   Example: to adapt the API product to specific requirements, a prediction function annotated with @InteractivePrediction can for example be specified as to how often the user may retrieve it within a certain period of time.

This exemplary implementation of the invention is written in the Python programming language. It is suitable for generating API products from Python source text created with any Python libraries available on the market in the field of data analysis and artificial intelligence. This covers the relevant individual applications in the field of data analysis and artificial intelligence.

The semantic annotations are implemented with the help of so-called Python decorators. The following types of semantic annotations are currently available:
Definition of communication interfaces:
   User-defined initialization of the API product
   Training of analytical models
   Interactive generation of predictions
   Asynchronous generation of predictions
   Starting batch processing jobs
   Starting data stream processing jobs
   Processing customer feedback on previously made predictions
Definition of information to be exchanged:
   Definition of the diagrammatic representation of general configuration parameters
   Definition of the diagrammatic representation of requests for predictions
   Definition of the diagrammatic representation of responses to requests for predictions
   Definition of the diagrammatic representation of hyperparameters for analytical models
   Definition of the diagrammatic representation of training data for analytical models
   Definition of the diagrammatic representation of user feedback on previously made predictions REST is for example employed as a communication interface.

These interfaces follow the OpenAPI standard and are therefore self-describing. Using publicly available source text generators, users can integrate the resulting API products into numerous applications and processes.

1-15. (canceled)

16. A computer-implemented method for producing a computer program product starting from a source text of artificial intelligence algorithms with at least one source text construct marked with at least one semantic annotation, the method comprising the following method steps:
a. providing a library of semantic annotations, containing:
semantic annotations for marking source text constructs of the source text of artificial intelligence algorithms;
logic sequences uniquely linked to the semantic annotations for generating communication interfaces and for embedding marked source text constructs;
b. providing a source text analysis component for analyzing the source text for the presence of the semantic annotations in the source text;
c. providing a communication interface generator for generating at least one communication interface;
d. using the source text analysis component to analyze the source text for a presence of at least one semantic annotation in the source text and transferring the at least one logic sequence, which is uniquely linked to the at least one semantic annotation that is present in the source text, from the library to the communication interface generator;
e. using the communication interface generator to read the at least one transferred logic sequence which is uniquely linked to the at least one semantic annotation present in the source text; and
f. using the communication interface generator to generate at least one communication interface on a basis of the at least one logic sequence read by the communication interface generator; and
g. embedding the at least one communication interface into the computer program product.

17. The method according to claim 16, which comprises preceding method step a. by:
marking at least one source text construct in the source text of the artificial intelligence algorithms with at least one semantic annotation from the library of semantic annotations.

18. The method according to claim 16, further comprising the following method steps, which precede method step e.:
cc. providing a communication interface provision component;
wherein in method step f. the at least one communication interface generated by the communication interface generator is transferred to the communication interface provision component;
wherein method step g. is executed by the communication interface provision component; and
wherein method step g. is followed by:
h. using the communication interface provision component to provide the generated computer program product.

19. The method according to claim 16, wherein the library of semantic annotations provided in method step a. comprises at least one configuration template which is uniquely linked to at least one logic sequence and which comprises definitions of configuration parameters for modifying the logic sequence, and wherein method steps d. and e. additionally comprise:
d. transferring at least one configuration template, which is uniquely linked to the at least one transferred logic sequence, from the library to the communication interface generator;
e. using the communication interface generator to read the at least one transferred configuration template, to which at least one transferred logic sequence is uniquely linked;
wherein method step e. is followed by and method step f. is preceded by:
ee. using the communication interface generator to generate at least one configuration interface on a basis of the at least one read logic sequence and on the basis of the at least one read configuration template, and providing the at least one generated configuration interface for modifying the at least one read logic sequence.

20. The method according to claim 19, wherein:
method step ee. additionally comprises:
ee. using the communication interface generator to receive at least one modification of the at least one read logic sequence via the configuration interface and modifying the at least one read logic sequence; and
method step f. comprises:
f. using the communication interface generator to generate at least one communication interface on a basis of the at least one modified logic sequence.

21. The method according to claim 16, which comprises, in accordance with method step f. using the communication interface generator to generate the at least one communication interface as an application programming interface.

22. The method according to claim 16, which comprises preceding method step d. by:
providing an input interface for receiving an input for expanding, deleting, or changing contents of the library of semantic annotations; and
expanding, deleting, or changing contents of the library of semantic annotations based on the input.

23. The method according to claim 16, wherein the at least one source text construct of the source text of the artificial intelligence algorithms marked with a semantic annotation from the library comprises at least one algorithm for regulating, controlling, diagnosing, monitoring, or simulating technical devices or systems.

24. A non-transitory computer program for producing a computer program product comprising commands, which, when the program is executed on a computer, cause the computer to execute the method according to claim 16.

25. The computer program according to claim 24, comprising:
a library of semantic annotations containing
semantic annotations for marking source text constructs of a source text of artificial intelligence algorithms;
logic sequences uniquely linked to the semantic annotations for generating communication interfaces and for embedding the marked source text constructs;
a source text analysis component configured for:
analyzing the source text for a presence of semantic annotations from the library in the source text; and
transferring at least one logic sequence that is uniquely linked to at least one semantic annotation present in the source text from the library to a communication interface generator;
a communication interface generator configured for:
reading at least one transferred logic sequence linked to at least one semantic annotation present in the source text;
generating at least one communication interface based on at least one read logic sequence; and
transferring at least one generated communication interface to a communication interface provision component; and
a communication interface provision component configured for:
embedding the at least one generated communication interface into the computer program product.

26. The computer program according to claim 25, which comprises an input interface configured for:
reading-in a source text of artificial intelligence algorithms comprising at least one semantic annotation for marking at least one source text construct of the source text of artificial intelligence algorithms in the source text; and
transferring the read-in source text to a source text analysis component.

27. The computer program according to claim 24, comprising an input interface for receiving an input for expanding, deleting, or changing the contents of the provided library of semantic annotations and/or for marking at least one source text construct of the source text with at least one semantic annotation from the library.

28. A non-transitory data carrier having stored thereon the computer program according to claim 24.

29. A computer program product produced with the method according to claim 16.

30. A data storage medium having stored thereon a computer program product produced with the method according to claim 16.
